(19) United States
(12) Patent Application Publication
(10) Pub. No.: US 2017/0325917 A1
(43) Pub. Date: Nov. 16, 2017

(54) ROOT ASSEMBLY WITH POSITION RECOGNITION

(71) Applicants: TAIWAN SHAN YIN INTERNATIONAL CO., LTD., KAOHSIUNG CITY 806 (TW); BIOMATE MEDICAL DEVICES TECHNOLOGY CO., LTD., KAOHSIUNG CITY 821 (TW)

(72) Inventor: CHIEN-TE WU, TAIPEI CITY 10576 (TW)

(21) Appl. No.: 15/152,897

(22) Filed: May 12, 2016

(51) Int. Cl. A61C 8/00

(52) U.S. Cl. CPC A61C 8/0093; A61C 8/0036; A61C 2008/0046

(57) ABSTRACT

A root assembly includes an implant body and a positioning device connected to the implant body. The implant body has a positioning hole formed through one end thereof and an engaging portion opposite to the positioning hole. The positioning hole has an end edge. The positioning device has a positioning seat where an artificial tooth is attached and a positioning unit extending through and out of the positioning seat. A first recognition portion is formed on the positioning seat. The location of the first recognition portion of the positioning seat corresponding to the end edge of the positioning hole can recognize that the positioning device is exactly positioned on the implant body, thereby preventing the positioning device from loosening.

### BACKGROUND OF THIS INVENTION

### 1. Field of this Invention

This invention relates to a dental root assembly and relates particularly to a root assembly whose positioning operation can be recognized to ensure a firm engagement between the positioning device and the implant body.

### 2. Description of the Related Art

Referring to FIG. 1 and FIG. 2, a conventional root assembly 1 includes an implant 11 and a positioning device 12 connected to the implant 11. A top end of the implant 11 forms a positioning hole 112. The implant 11 further has an engaging portion 111 opposite to the positioning hole 112. The positioning hole 112 is partitioned into an engagement area 114 and a positioning area 113 formed between the engagement area 114 and the top end. The positioning device 12 has a seat 121 where an artificial tooth 2 is attached and a positioning unit 122 extending through and out of the seat 121. The positioning unit 122 has a spirally threaded section 1221. When the threaded section 1221 is threadedly engaged with the engagement area 114, the seat 121 is driven by the positioning unit 122 and then positioned on the positioning area 113.

In use, after the implant 11 is implanted into an alveolar bone (not shown) to complete a first stage of an implanting treatment, the positioning unit 122 fixes the seat 121 on the implant 11 threadedly to help an engagement between the implant 11 and the alveolar bone. Finally, a crown impression is carried out, and then a finished artificial tooth 2 is attached to the positioning device 12 by an adhesive used in dentistry to achieve the full implanting treatment.

The use of the conventional root assembly 1, as shown in FIG. 2, still has problems. For example, a screw-in operation of the positioning unit 122 into the engagement area 114 stops when the dentist thinks that the seat 121 is well attached to the positioning area 113 according to his experiences and a determination of an X-ray machine. However, because part of the seat 121 and the implant 11 is easily shaded by the gum and a peripheral surface of the seat 121 is smooth, the X-ray machine may fail to reveal full states, with the result that the determination is not always correct. Furthermore, the dentist usually uses his subjective sensation and experiences to attach the positioning device 12 to the implant 11, but there is still possibility of causing the positioning device 12 to stand slantwise and position unstably. If the positioning device 12 is not held in position, the artificial tooth 2 becomes loose easily. Even though the positioning device 12 is successfully held in position, the implant 11 and seat 121 may rub against each other by an undue tight screwing action. This situation is unfavorable for mounting the artificial tooth 2 on the positioning device 12.

### SUMMARY OF THIS INVENTION

An object of this invention is to provide a root assembly which can recognize the state of the movement of the positioning device during the screwing operation to ensure that the positioning device is stably attached to the implant body without regard to the shading of the gum and attain a good, precise and firm positioning effect of the artificial tooth.

A root assembly with position recognition of this invention includes an implant body and a positioning device connected to the implant body. The implant body has a positioning hole formed through one end thereof and an engaging portion opposite to the positioning hole. The positioning hole has an end edge formed on the one end of the implant body and is partitioned into an engagement area and a positioning area formed between the engagement area and the end edge. The positioning device has a positioning seat where an artificial tooth can be attached and a positioning unit extending through and out of the positioning seat. The positioning seat has a first recognition portion formed thereon. The first recognition portion meets the end edge of the positioning hole to recognize that the positioning seat is positioned on the implant body. The positioning unit has a threaded section capable of threadedly engaging the engagement area of the implant body. The positioning unit passes through the positioning seat and activates a movement of the positioning seat to threadedly engage the implant body. The location of the first recognition portion corresponding to the end edge of the positioning hole functions as a mark or recognition to allow the user to ensure that the positioning device is exactly fixed on the implant body. Therefore, an undue tight screwing action or a loose combination between the positioning device and the implant body can be prevented, and the problem that the artificial tooth becomes loose can also be solved.

Preferably, the positioning unit has a second recognition portion formed near the threaded section. The second recognition portion is situated at a place corresponding to the first recognition portion and the end edge of the positioning hole to recognize an engagement between the positioning unit and the positioning seat.

Preferably, at least one recess is formed on said positioning seat so that the recess can be filled with an additive to attach the artificial tooth to the positioning device more stably.

Preferably, the first recognition portion can be in a form of an annular groove, engraved lines or other suitable designs.

Preferably, the second recognition portion can also be in a form of an annular groove, engraved lines or other suitable designs.

The advantages of this invention are more apparent upon reading the following descriptions in conjunction with the drawings.

### BRIEF DESCRIPTION OF THE DRAWINGS

FIG. 1 is an exploded view showing a conventional structure;

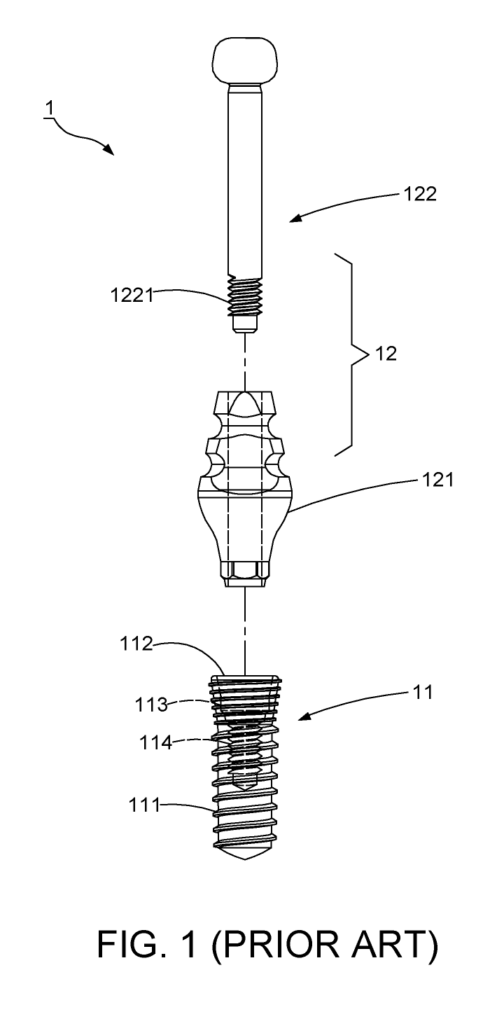

FIG. 2 is a schematic view showing the conventional structure in use;

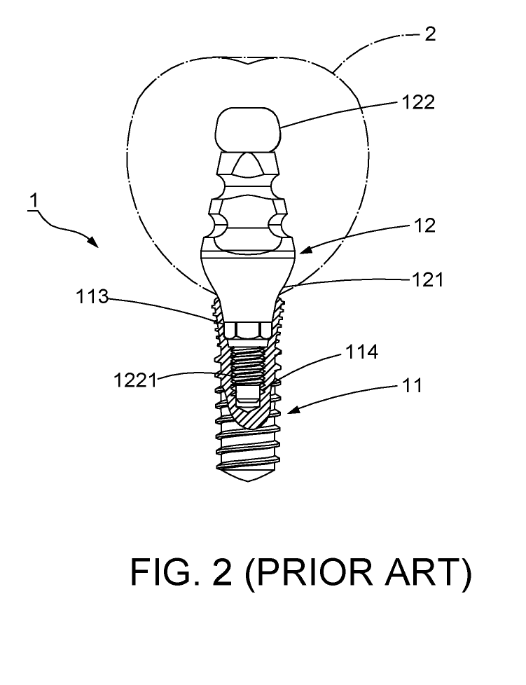

FIG. 3 is an exploded view showing a first preferred embodiment of this invention;

FIG. 4 is a schematic view showing the first preferred embodiment of this invention in use;

FIG. 5 is a schematic view showing another variation of the first preferred embodiment; and

FIG. 6 is a schematic view showing a second preferred embodiment of this invention.

### DETAILED DESCRIPTION OF THE PREFERRED EMBODIMENTS

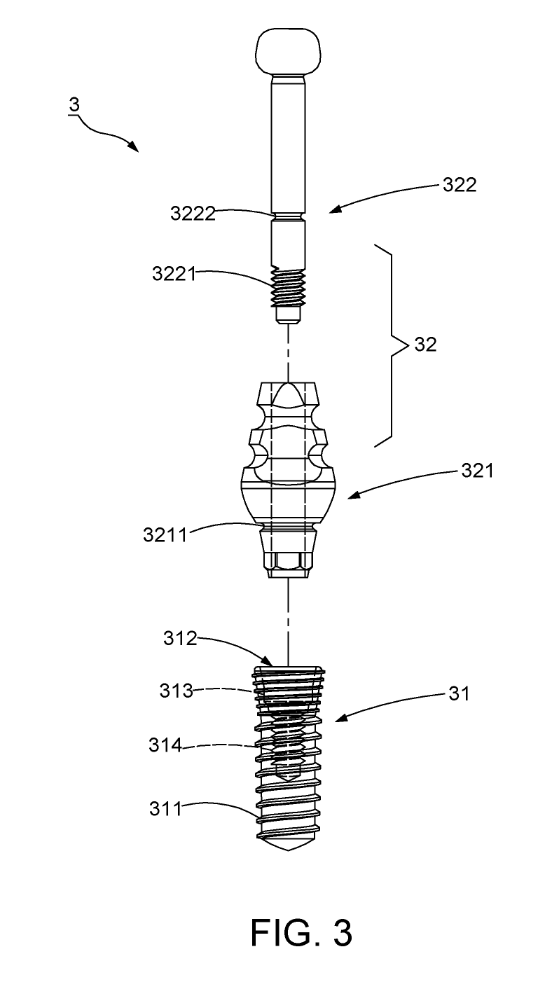

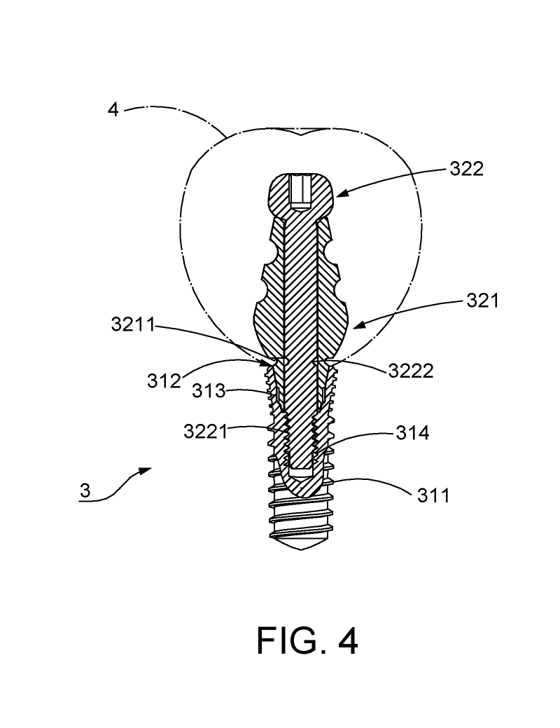

Referring to FIG. 3 and FIG. 4, a root assembly 3 with position recognition of a first preferred embodiment comprises an implant body 31 and a positioning device 32 connected to the implant body 31. The implant body 31 has a positioning hole 312 formed through one end thereof and an engaging portion 311 disposed on another end thereof opposite to the positioning hole 312. The positioning hole 312 has an end edge formed on the one end and is partitioned into an engagement area 314 away from the end edge and a positioning area 313 formed between the engagement area 314 and the end edge.

The positioning device 32 includes a positioning seat 321 to which an artificial tooth 4 is connected and a positioning unit 322 extending through and out of the positioning seat 321. A first recognition portion 3211 is formed on the positioning seat 321 and adapted to meet the end edge of the positioning hole 312 in order to recognize that the positioning seat 321 is really positioned or fixed on the implant body 31. Furthermore, the positioning unit 322 has a threaded section 3221 disposed on one end thereof. The positioning unit 322, preferably, can also have a second recognition portion 3222 formed near the threaded section 3221. Likewise, the second recognition portion 3222 can be situated at a place corresponding to the first recognition portion 3211 and the end edge of the positioning hole 312, thereby functioning as a mark to recognize that the positioning unit 322 is really engaged with the positioning seat 321.

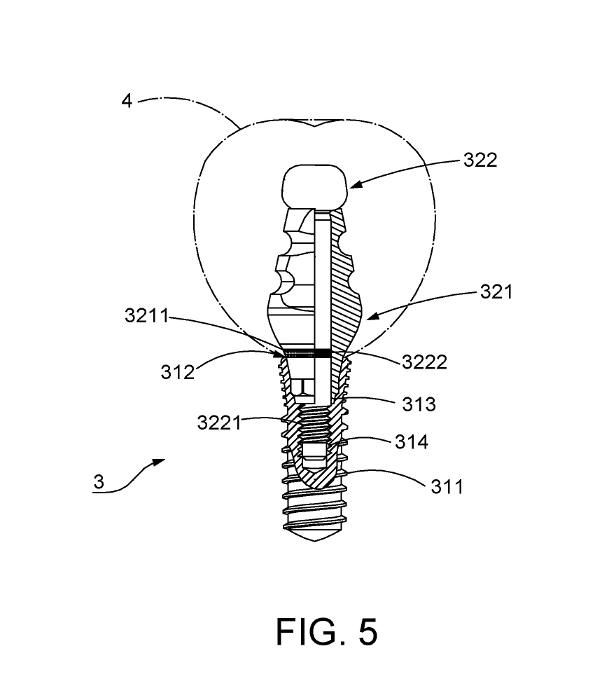

Please be noted that the first recognition portion 3211 and the second recognition portion 3222 can be, but not limited to, in a form of an annular groove shown in FIG. 3 and FIG. 4, engraved lines shown in FIG. 5 or other suitable designs. Both of the first recognition portion 3211 and the second recognition portion 3222 allow the dentist to recognize the movement or positioning state of the positioning device 32 easily and exactly during the implanting treatment.

The operation of this invention is described with the aid of FIG. 3 and FIG. 4. The engaging portion 311 of the implant body 31 is implanted into a pre-drilled hole of an alveolar bone (not shown) to complete a first stage of the implanting treatment. A second stage of the treatment is carried out by extending the threaded section 3221 of the positioning unit 322 through and out of the positioning seat 321. The entry of the positioning unit 322 into the positioning seat 321 allows both of the recognition portions 3211, 3222 to meet each other. In other words, the second recognition portion 3222 is fixedly situated at a place corresponding to the first recognition portion 3211, and this allows the positioning seat 321 to be driven and moved by the positioning unit 322. Then, the threaded section 3221 out of the positioning seat 321 enters the positioning hole 312 of the implant body 31 and gradually engages the engagement area 314. During the gradual engagement between the threaded section 3221 and the engagement area 314, the positioning seat 321 gradually enters the positioning area 313. Because the first recognition portion 3211 is annularly formed on the positioning seat 321, the dentist can visually know the movement of the positioning seat 321 and recognize whether the first recognition portion 3211 meets the end edge of the positioning hole 312. Accordingly, the problem that the positioning seat 321 and the positioning hole 312 unduly rub against each other can be solved. The movement of the positioning device 32 stops when the first recognition portion 3211 meets the end edge of the positioning hole 312. After the visual recognition is done, a further image capturing method can be used to determine whether the locations of the recognition portions 3222, 3211 fitly meet the end edge of the positioning hole 312 and then make a final precise determination. Thus, it is certain that the positioning seat 321 is fully positioned on the implant body 31 to prevent an undue tight screwing action and a loose combination problem. Finally, a crown impression is executed, and then an artificial tooth 4 is well made and attached to the positioning seat 321 to complete the entire implanting treatment.

Accordingly, the first recognition portion 3211 and the second recognition portion 3222 function as a mark of recognizing and determining the position quickly in an implanting operation, thereby preventing the positioning device 32 and the implant body 31 from unduly rubbing against each other because of an over tight screwing operation between the positioning seat 321 and the positioning hole 312. The recognition portions 3211, 3222 also prevents the artificial tooth 4 from loosening because of the incomplete positioning problem or the slanting state of the positioning device 32. Therefore, the structure of this invention increases the convenience and accuracy of the implanting operation.

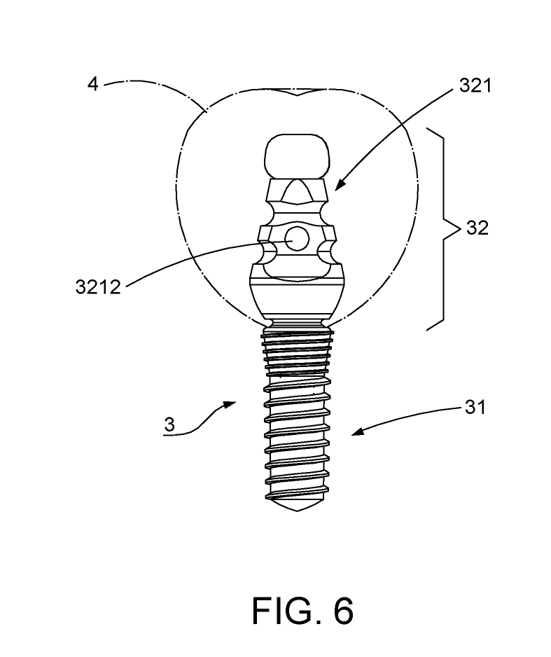

Referring to FIG. 6, a root assembly 3 of a second preferred embodiment has an implant body 31 and a positioning device 32. Other detailed elements and concatenation of correlated elements of the second preferred embodiment are identical to those of the first preferred embodiment and herein are omitted. The second preferred embodiment is characterized in that at least one recess 3212 is formed on the positioning seat 321. Accordingly, when the artificial tooth 4 coated with a dental adhesive (not shown) is to be attached to the positioning seat 321, the recess 3212 can receive the residual adhesive to adhere the artificial tooth 4 to the positioning device 32 more stably. This arrangement precludes the occurrence of an occlusal interference of the artificial tooth 4.

To sum up, this invention takes advantage of a first recognition portion of the positioning seat corresponding to the end edge of the positioning hole of the implant body to allow users to recognize the position visually and quickly. The second recognition portion formed on the positioning unit also assists an image capturing system in recognizing, correcting and positioning more precisely, thereby preventing an undue tight screw-in operation between the positioning device and the implant body and preventing an incomplete combination and a slanting state of the positioning device. Thus, the mounting of the artificial tooth can be unaffected, and the convenience and accuracy of the implanting operation can be largely increased.

While the embodiments of this invention are shown and described, it is understood that further variations and modifications may be made without departing from the scope of this invention.

What is claimed is:

1. A root assembly with position recognition comprising:
an implant body including a positioning hole formed through one end thereof and an engaging portion opposite to said positioning hole, said positioning hole having an end edge and being partitioned into an engagement area away from said end edge and a positioning area formed between said engagement area and said end edge; and
a positioning device connected to said implant body and including a positioning seat to which an artificial tooth is connected and a positioning unit extending through and out of said positioning seat, said positioning unit having a threaded section disposed on one end thereof, said threaded section of said positioning unit being capable of threadedly engaging said engagement area of said positioning hole to allow said positioning seat to be positioned on said positioning area of said positioning hole;
wherein a first recognition portion is formed on said positioning seat, said first recognition portion meeting said end edge of said positioning hole when said positioning seat is positioned on said positioning area of said positioning hole to recognize a firm engagement between said positioning seat and said implant body.

2. The root assembly according to claim 1, wherein said positioning unit has a second recognition portion formed near said threaded section, said second recognition portion being situated at a place corresponding to said first recognition portion and said end edge of said positioning hole to recognize an engagement between said positioning unit and said positioning seat.

3. The root assembly according to claim 1, wherein at least one recess is formed on said positioning seat.

4. The root assembly according to claim 1, wherein said first recognition portion is in a form of an annular groove.

5. The root assembly according to claim 2, wherein said first recognition portion and said second recognition portion are in a form of an annular groove.

6. The root assembly according to claim 1, wherein said first recognition portion is formed by engraved lines.

7. The root assembly according to claim 2, wherein said first recognition portion and said second recognition portion are formed by engraved lines.
